(19) United States
(12) Patent Application Publication
(10) Pub. No.: US 2008/0244538 A1
(43) Pub. Date: Oct. 2, 2008

(54) Multi-core processor virtualization based on dynamic binary translation

(76) Inventors: Sreekumar R. Nair, Santa Clara, CA (US); Youfeng Wu, Palo Alto, CA (US)

Correspondence Address: TROP PRUNER & HU, PC, 1616 S. VOSS ROAD, SUITE 750, HOUSTON, TX, 77057-2631, US

(21) Appl. No.: 11/728,347

(22) Filed: Mar. 26, 2007

(51) Int. Cl. G06F 9/45

(52) U.S. Cl. 717/137

(57) ABSTRACT

A processor virtualization abstracts the behavior of a processor instruction set architecture from an underlying micro-architecture implementation. It is capable of running any processor instruction set architecture compatible software on any micro-architecture implementation. A system wide dynamic binary translator translates source system programs to target programs and manages the execution of those target programs. It also provides the necessary and sufficient infrastructure requires to render multi-core processor virtualization.

### BACKGROUND

This relates generally to computers or processor-based systems and, particularly, to processor virtualization.

Some platforms or computers may include multiple processors called multiple core processors. These multiple processors or multiple cores may be maintained within the single integrated circuit in some cases.

Processors operate under a set of instructions called an instruction set. Different processors may have different instruction set architectures. This means that given micro-architectures may be matched to specific instruction set architectures, limiting the usefulness of various systems.

### BRIEF DESCRIPTION OF THE DRAWINGS

FIG. 1 is a system depiction of one embodiment of the present invention; and

FIG. 2 is a flow chart for the embodiment shown in FIG. 1.

### DETAILED DESCRIPTION

A processor virtualization may abstract the behavior of a processor instruction set architecture from the underlying micro-architecture implementations, including multiprocessors. The processor virtualization is the capability to run any processor instruction set architecture compatible software on any micro-architecture implementation.

Processor virtualization may be achieved by a system-wide dynamic binary translator (SysDBT), that translates “source” system programs to “target” programs and manages the execution of the target programs. The binary translator provides the necessary infrastructure to render multi-core processor virtualization.

In some embodiments, through the use of a dynamic binary translator, it is possible to execute a source many core system on a target many core system based on a processor with a different instruction set architecture. In this scenario, the dynamic binary translator boots on the target system and boots the source many core system using dynamic binary translation. It then runs any system software components on the target system, together with the application processes and threads spawned by the system software. Examples of system components may include system software like basic input/output systems or extensible firmware interfaces, operating systems, virtual machine monitors, and hypervisors, as examples.

The translator may be a key component in hardware/software co-design for processors in which the dynamic binary translator is integrated into the co-designed cores. The translator may also provide the necessary infrastructure for the multi-core processor virtualization, balancing hardware and software resources to efficiently implement an architecture in some embodiments.

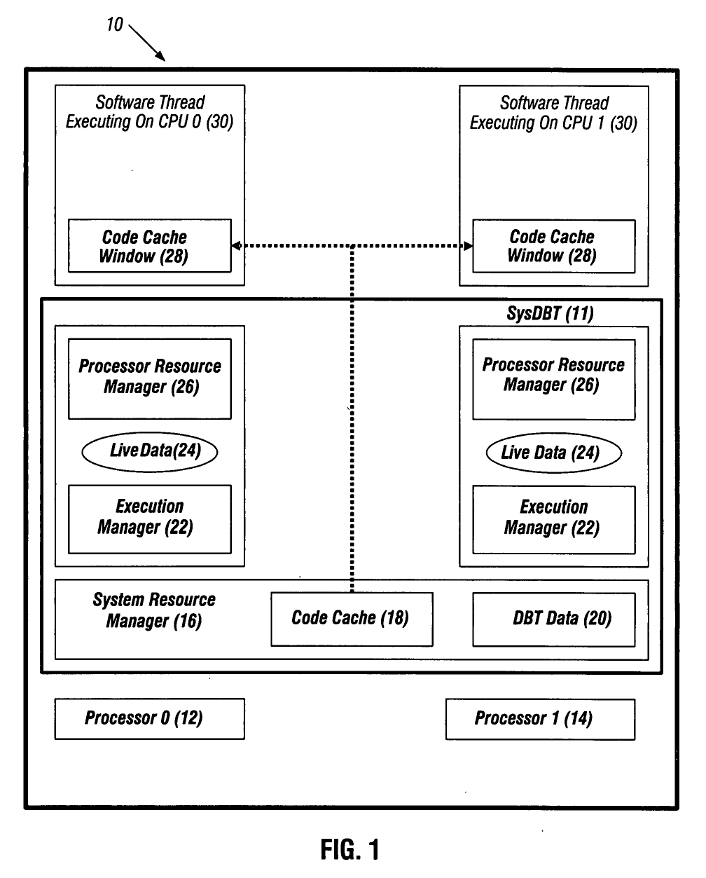

The dynamic binary translator 11, shown in FIG. 1, may be architected as a composite monolithic software component in a system 10. It may include a system resource manager 16 that provides centralized services like memory management, code cache management, sharing translations across processors, and the like. A processor resource manager 26 may be provided for each processor 12, 14 to operate on live data 24. It comprises the management chores associated with processor resources like system memory map, memory management modes, architected features for demand paging, handling of interrupts, traps and tasks, and the like. An execution manager 22 may also be provided for each processor 12, 14 of a multi-core system. It provides an interface and manages the on-demand translation of the instruction stream. The manager 22 may also contain an interpreter needed to execute the code that does not run in protected mode of memory management.

In FIG. 1, a dual processor system is illustrated, but more processors may be used. The system resource manager 16 provides centralized management of system wide resources. The central processing unit (CPU) resource manager 26 manages the per-thread resources on the processor. The execution manager 22 manages translation and execution of code dispatched to a processor. Various data structures are also active during the operation of the translator, most notably including the shared code cache 18 which is windowed into the linear address spaces of the software threads executing on the processors as indicated at 30 and 28. As indicated at 30, software threads execute on a given processor in a linear address space. This could include operating system, virtual machine monitor, hypervisor, user applications, or process threads.

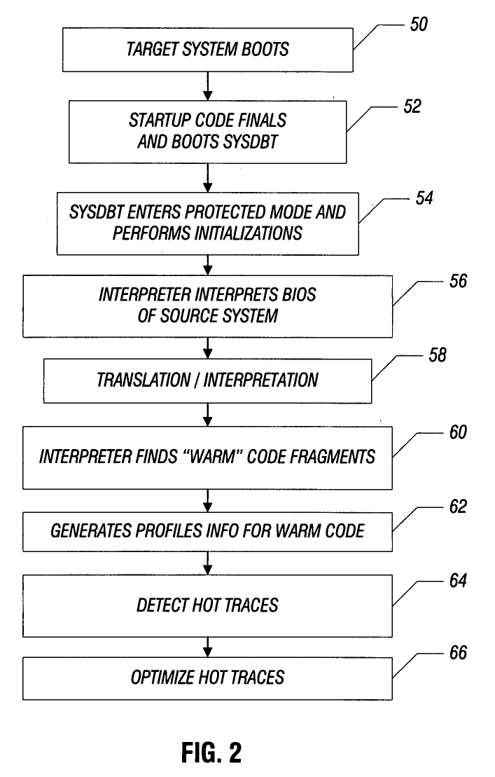

Referring to FIG. 2, the target system boots up from the startup code in a flash memory or read-only memory on a bootstrap processor, starting at the appropriate hardware reset address as indicated in block 50. Once initialized, the startup code looks for a bootable component in one of the bootable media on the system, where it finds the dynamic binary translator and boots it, as indicated in block 52. Soon thereafter, the dynamic binary translator boots up, its code 28 and data 20 reside in a safe temporary memory location.

The dynamic binary translator then enters the protected mode of memory management and performs the necessary initializations, as indicated in block 54. At this time, the translator may operate only on static data. An interpreter that is part of the execution manager 22 takes control, starts interpreting the basic input/output system of the source system being translated, as indicated in block 56. Prior to starting this interpretation of the source basic input/output system, the architected state of the processor is initialized to the state at the time of a power-on reset.

As part of the initialization, the resource manager 16 pre-allocates a sufficient chunk of physical memory needed for the functioning of the translator, by manipulating the system memory map returned by the basic input/output system, thereby making this chunk of memory invisible to any other system software. The dynamic memory allocator in the translator is started and any subsequent phases of the translator can freely consume dynamically allocated memory from the pre-allocated chunk. At this time, the system resource manager 16 initializes the code cache management as part of which, it allocates a chunk of physical memory for the shared code cache 18. The shared code cache 18 contains a single pool of translations shared between all software threads running on the system. It also contains translation data needed for quick lookup during execution of translated code. For example, runtime linking of indirect branches may occur without having to switch context into the translator and back just to lookup the translated address in some embodiments. The single pool of translation caters efficiently to all the software execution contexts running on the system. However, since the translations may be keyed on physical memory addresses, the actual sharing of translations may happen only among software threads in the same isolation domain. An isolation domain is an execution space, such that any attempt to access the code or data credentials across such execution space, is considered a violation of system security or privacy. For example, a guest operating system running on a virtual machine monitor is an isolation domain, while the virtual machine monitor itself is another isolation domain.

The shared code cache 18 is later windowed into the linear address space of the different software components running on the system, indicated at 28 in FIG. 1. The integrity of shared code cache 18 is preserved even in the presence of asynchronous modifications to physical memory pages. The shared pool of translations may also pose no security or privacy threads by virtue of the fact that the shared code cache 18 cannot be accessed across isolation domains.

After the basic input/output system has checked for the presence and functionality of all processors other than the bootstrap processor, the system resource manager 16 initializes the application processors by sending a startup inter-processor interrupt to each of the application processors. One of the arguments in the interrupt may be a pointer to a bootup sequence to be executed on the application processor. Once booted on the application processor, the resource manager 16 initializes the processor and installs a handler for the startup inter-processor interrupt such that the interpreter of the translator is invoked when another processor tries to dispatch a new thread to be executed on this application processor.

When a fragment of the program dispatched to the application processor has executed more than a predetermined threshold, the translator resorts to normal translation, at which time it can execute shared translations from other processors which are installed in the shared code cache 18, as indicated in FIG. 2 at block 58.

This sharing of translations across processors cuts down on the overall number of translations happening across the system and enhances the scalability of many core systems running under the translator. Ahead-of-time speculative translations can also be dispatched on idle processor cores to redeem future translation costs. This may enable seamless continuous optimizations and the heuristics for such speculative translations may be optimized to minimize code cache pollution.

The translator may also be equipped with an interpreter for situations where the translation is unsuitable. The translation may be unsuitable whenever code executes in a real address mode, such as basic input/output system. It may also be unsuitable when a cold code is executed, since interpretation may be less expensive than translation if the code is executed only a few times. Whenever the code cache window 28 gets evicted from the linear address space of a program 30 and another suitable free linear address slot is not available in the program's address space, translation may be unsuitable.

Otherwise, the combination of translation and/or interpretation is implemented as indicated in block 58.

The interpreter finds code fragments that are executed more than a few times, such as three times, and are, hence, turned warm code, as indicated in block 60 in FIG. 2. The interpreter requests the execution manager 22 to perform warm code translation. The warm code will be instrumented to generate profile information (block 62) needed to detect hot traces based on a profiling algorithm, such as the most recently executed tail (MRET) algorithm (block 64).

Once a hot trace is detected because it is executed more than a certain number of times, such as 2000 times, it may be re-optimized by a region optimizer to further enhance its efficiency, as indicated in block 66. The warm code and hot traces may reside in the code cache 18 that is windowed into all the address spaces of software processes running on the system.

The code cache windowing scheme ensures that code executing on the system is either interpreted or is executed only out of the code cache window. Thus, the translator retains control over the system. As soon as translated code is integrated into a code cache, it is immediately visible to all software threads into which the code cache is windowed. However, care may be exercised while linking newly translated code to existing translated code in such a way as to ensure coherent execution. For example, it may be advantageous to make sure that no processor is executing the current code that gets altered by the linking, as in the case of a piece of newly translated code inserted before the backedge of a loop. The code cache windowing scheme also ensures that relations in the code cache can be shared across the linear address spaces in the same isolation domain.

By being able to operate on low level instruction streams, the translator may permit any software component or user application processor or threads to be translated and executed on a system in a seamless manner. The translator may also efficiently manage a single pool of translations that can be shared across the same isolation domain on a system in some cases. Sharing of translations may happen in the physical address space and, hence, the same code need not be translated over and over again in multiple linear or virtual address spaces of various software threads executing on the system. Instead, a single, shared, truly re-locatable code cache is windowed into any free slot of sufficient size in all linear address spaces to facilitate all software that threads to execute the same translated code efficiently. A special style of code generation may render the translated code truly re-locatable to the linear address spaces.

Although the translated code may correspond to different system software and user application processes and threads from multiple isolation domains, they all co-exist in the shared code cache. The translator protects system level security. The code cache windowing may minimize the translation times, in some embodiments, reducing redundant translations across processors and helping to keep the code cache as compact as possible.

Unlike classical virtual machine monitors, the translator does not require the other system software running on the system to be de-privileged. The translator may exist as an independent execution context in ring 0 and may maintain control over the system at all times, while other execution contexts belonging to system software or user applications communicate with the translator by way of various types of translation dispatch codes. For example, via a trap into a translator execution context to perform translation related chores.

The translator may also handle the translation of exceptional code sequences corresponding to asynchronous events, like handling interrupts and traps and task switching using on-demand translation. On-demand translation may rely on virtualization of the system descriptor tables, including interrupt, global, and local descriptor tables, and prepares them to start translating these exceptional sequences only when they are asynchronously initiated on the system.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A computer readable medium storing instructions that cause a computer to:
use a dynamic binary translator to translate a source system program using one instruction set architecture to a target program using a different instruction set architecture;
manage the execution of the target program;
boot the target system; and
boot a source system program using the translator and running system software components on the target program.

2. The medium of claim 1 storing instructions to implement multi-core virtualization.

3. The medium of claim 2 storing an interpreter with said translator.

4. The medium of claim 3 storing instructions to use said interpreter to find code lines executed more than a first number of times.

5. The medium of claim 4 storing instructions to generate profile information for said code lines.

6. The medium of claim 5 storing instructions to detect code lines executed more than a second number of times, said second number of times greater than said first number of times.

7. A system comprising:
a first processor;
a second processor; and
a dynamic binary translator coupled to said processors, said dynamic binary translator to translate a source system program using one instruction set architecture to a target program using a different instruction set architecture and to boot said source system program.

8. The system of claim 7 to implement multi-core virtualization.

9. The system of claim 7, said translator including an interpreter.

10. The system of claim 7, said interpreter to find code lines executed more than a first number of times.

11. The system of claim 10, said translator to generate profile information for said code lines.

12. The system of claim 11, said translator to detect code lines executed more than a second number of times, said second number of times greater than said first number of times.
